(19) United States
(12) Patent Application Publication
(10) Pub. No.: US 2026/0108999 A1
(43) Pub. Date: Apr. 23, 2026

(54) GRINDING APPARATUS

(71) Applicant: Samsung Electronics Co., Ltd., Suwon-si (KR)

(72) Inventors: Saeyoung Kim, Suwon-si (KR); Kyungyeol Kim, Suwon-si (KR); Bongsu Cho, Suwon-si (KR); Jwahyeon Kim, Suwon-si (KR); Hyuntae Kim, Suwon-si (KR)

(21) Appl. No.: 19/252,804

(22) Filed: Jun. 27, 2025

(30) Foreign Application Priority Data
Oct. 23, 2024 (KR) 10-2024-0145903

(51) Int. Cl. B24B 41/047; F16F 9/32

(52) U.S. Cl. CPC B24B 41/047; F16F 9/3207; F16F 2224/025

(57) ABSTRACT

A grinding apparatus includes a spindle having a rotating shaft; a mount disk having an upper disk fixed to a lower portion of the rotating shaft, a lower disk fastened to the upper disk, and a plurality of vibration absorbing dampers fixedly supported between the upper disk and the lower disk that are fastened to each other; and a grinding wheel detachably mounted on the mount disk.

### PRIORITY STATEMENT

This application claims priority under 35 U.S.C. § 119 to Korean Patent Application No. 10-2024-0145903, filed on Oct. 23, 2024, in the Korean Intellectual Property Office (KIPO), the contents of which are herein incorporated by reference in their entirety.

### BACKGROUND

### 1. Field

Example embodiments relate to a grinding apparatus. More particularly, example embodiments relate to a grinding apparatus configured to grind a surface of a wafer.

### 2. Description of the Related Art

In order to reduce a thickness of a wafer, a backside surface of the wafer may be ground using a grinder. The grinder may include a grinding wheel that comes into contact with the backside surface of the wafer, a spindle that applies a rotational force to the grinding wheel, etc. In related arts, the grinding wheel may partially remove the backside surface of the wafer to a desired thickness by vertically downward movement of the spindle. However, vibrations of the spindle generated during the grinding may act as an uncontrollable factor for vertical movement of the spindle. It may be important to attenuate or damp vibrations of the spindle, as well as to secure rigidity of a mount disk for mounting the grinding wheel to the spindle.

### SUMMARY

Example embodiments provide a grinding apparatus capable of effectively attenuating or damping vibrations of a spindle.

According to example embodiments, a grinding apparatus includes a spindle having a rotating shaft; a mount disk having an upper disk fixed to a lower portion of the rotating shaft, a lower disk fastened to the upper disk, and a plurality of vibration absorbing dampers fixedly supported between the upper disk and the lower disk that are fastened to each other; and a grinding wheel detachably mounted to the mount disk.

According to example embodiments, a grinding apparatus includes a spindle having a rotating shaft, a mount disk fixed to a lower portion of the rotating shaft, and a grinding wheel detachably mounted on the mount disk. The mount disk includes a lower disk having a plurality of receiving recesses, vibration absorbing dampers respectively arranged in the plurality of receiving recesses, and an upper disk coupled to the lower disk and covering the vibration absorbing dampers.

According to example embodiments, a grinding apparatus includes a spindle having a rotating shaft; a mount disk having an upper disk fixed to a lower portion of the rotating shaft, a lower disk fastened to the upper disk, and a plurality of vibration absorbing dampers fixedly supported between the upper disk and the lower disk that are fastened to each other; and a grinding wheel detachably mounted to the mount disk. Each of the vibration absorbing dampers includes a damper housing having an annular column-shaped receiving space therein, a spring disposed within the receiving space of the damper housing, and a damping fluid partially filling the receiving space.

According to example embodiments, a grinding apparatus may include a spindle, a damper-type mount disk, and a grinding wheel. The damper-type mount disk may include an upper disk, a lower disk fastened to the upper disk, and a plurality of vibration absorbing dampers fixedly supported between the upper disk and the lower disk that are fastened to each other. Each of the vibration absorbing dampers may include a damper housing having an annular column-shaped receiving space therein, a spring disposed within the receiving space of the damper housing, and a damping fluid partially filling the receiving space.

The damper-type mount disk may primarily dampen or alleviate vibration in a Z-axis direction that occurs during a grinding process, to effectively dampen vibration of the spindle.

### BRIEF DESCRIPTION OF THE DRAWINGS

Example embodiments will be more clearly understood from the following detailed description taken in conjunction with the accompanying drawings. FIGS. 1 to 14 represent non-limiting, example embodiments as described herein.

FIG. 1 is a perspective view illustrating a wafer backside processing apparatus in accordance with example embodiments.

FIG. 2 is a perspective view illustrating a grinding apparatus of FIG. 1.

FIG. 3 is a cross-sectional view illustrating a wafer being ground by a grinding wheel of FIG. 2.

FIG. 4 is a block diagram illustrating a grinding apparatus in accordance with example embodiments.

FIG. 5 is an exploded perspective view illustrating the grinding apparatus of FIG. 4.

FIG. 6 is an exploded perspective view illustrating a mount disk of FIG. 5.

FIG. 7 is an exploded cross-sectional perspective view illustrating the mount disk of FIG. 6.

FIG. 8 is an exploded cross-sectional view illustrating the mount disk of FIG. 5.

FIG. 9 is a perspective view illustrating a plurality of vibration absorbing dampers arranged on a lower disk of FIG. 5.

FIG. 10 is a cross-sectional view illustrating the mount disk of FIG. 5.

FIG. 11 is a plan view illustrating a lower surface of an upper disk of the mount disk of FIG. 5.

FIG. 12 is a plan view illustrating an upper surface of the lower disk of the mount disk of FIG. 5.

FIG. 13 is a partially cut-away perspective view illustrating the vibration absorbing damper of the mount disk of FIG. 6.

FIG. 14 is a cross-sectional view illustrating the vibration absorbing damper of FIG. 13.

### DETAILED DESCRIPTION OF EXAMPLE EMBODIMENTS

Hereinafter, example embodiments will be explained in detail with reference to the accompanying drawings. The invention may, however, be embodied in many different forms and should not be construed as limited to the example embodiments set forth herein. It should also be emphasized that the disclosure provides details of alternative examples, but such listing of alternatives is not exhaustive. Furthermore, any consistency of detail between various examples should not be interpreted as requiring such detail.

Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

Spatially relative terms, such as “beneath,” “below,” “lower,” “above,” “upper,” “top,” “bottom,” “front,” “rear,” and the like, may be used herein for ease of description to describe positional relationships, such as illustrated in the figures, for example. It will be understood that the spatially relative terms encompass different orientations of the device in addition to the orientation depicted in the figures.

Items described in the singular herein may be provided in plural, as can be seen, for example, in the drawings. Thus, the description of a single item that is provided in plural should be understood to be applicable to the remaining plurality of items unless context indicates otherwise.

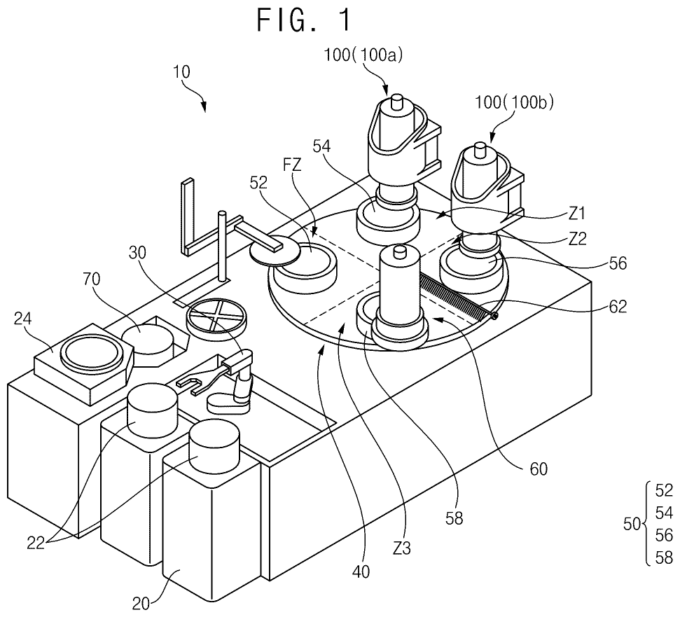

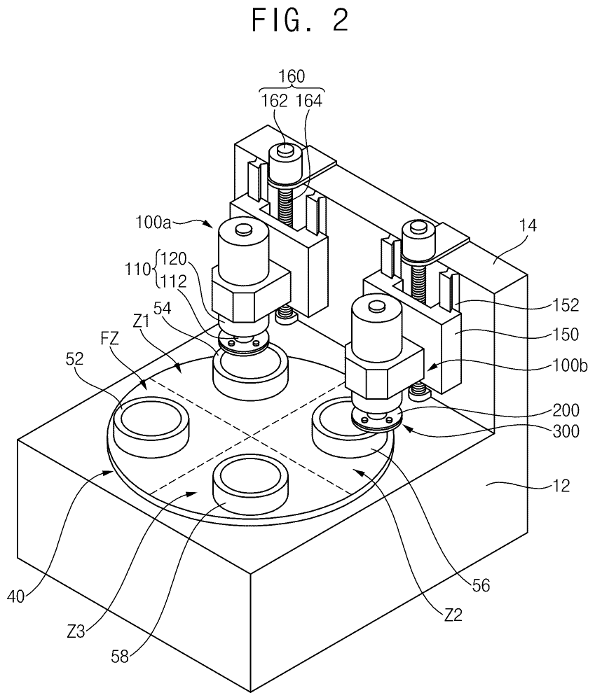

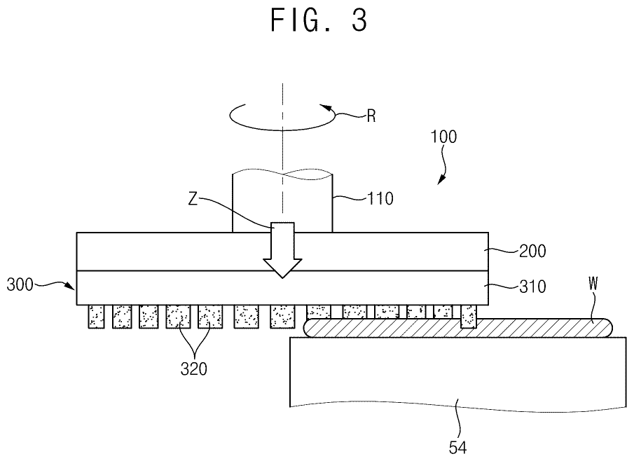

FIG. 1 is a perspective view illustrating a wafer backside processing apparatus in accordance with example embodiments. FIG. 2 is a perspective view illustrating a grinding apparatus of FIG. 1. FIG. 3 is a cross-sectional view illustrating a wafer being ground by a grinding wheel of FIG. 2.

As used herein, the term “wafer” may be a thin slice of semiconductor material. Typical examples of useful semiconductor materials are: Group IV materials, such as Si, C, or Ge, or alloys of these such as SiC or SiGe; Group II-VI compounds (including binary, ternary, and quaternary forms), e.g., compounds formed from Group II materials such as Zn, Mg, Be or Cd and Group VI materials such as Te, Se or S, such as ZnSe, ZnSTe, or ZnMgSTe; and Group III-V compounds (including binary, ternary, and quaternary forms), e.g., compounds formed from Group III materials such as In, Al, or Ga and group V materials such as As, P, Sb or N, such as InP, GaAs, GaN, InAlAs, AlGaN, InAlGaAs, etc. The wafer may be a precursor to a semiconductor device.

Referring to FIGS. 1 to 3, a wafer backside processing apparatus 10 may include a wafer stage 20, a turn table 40, a plurality of chuck tables 50, a plurality of grinding apparatuses 100, and a polishing apparatus 60. In addition, the wafer backside processing apparatus 10 may further include a position adjustment table 24, a transfer robot 30, a spinner table 70, etc.

In example embodiments, a wafer cassette 22 may be loaded onto the wafer stage 20. A plurality of wafers may be stored inside the wafer cassette 22. A wafer may be moved from the wafer cassette 22 to the position adjustment table 24 using the transfer robot 30. The position adjustment table 24 may have a function of aligning the wafer. Then, the wafer aligned on the position adjustment table 24 may be transferred to the turn table 40 using a transfer arm.

The turn table 40 may be provided as a loader station where the wafer backside processing process is performed. The plurality of chuck tables 50 may be provided on the turn table 40. The chuck tables 50 may be continuously changed in position by a rotation of the turn table 40. For example, first, second, third and fourth chuck tables 52, 54, 56, 58 may be arranged to correspond to four zones FZ, Z1, Z2, Z3 of the turn table 40. Each of the first, second, third and fourth chuck tables 52, 54, 56, 58 may support and rotate a wafer whose backside is to be processed.

After the wafer W is loaded onto the first chuck table 52 in a standby zone FZ as a standby station, the first chuck table 52 may be moved to the first zone Z1. The first zone Z1 may be provided as a first grinding station. In the first grinding station, a backside surface of the wafer may be roughly ground (rough polished) to reduce a thickness of the wafer. A first grinding apparatus 100a may be arranged in the first zone Z1. The first grinding apparatus 100a may include a spindle 110 having a rotating shaft 112 that is connected to a driving motor and is rotatable about its own axis and a grinding wheel 300 that rotates by the rotating shaft 112 to grind the backside surface of the wafer.

After the rough grinding is completed in the first zone Z1, the first chuck table 52 may be moved to the second zone Z2. The second zone Z2 may be provided as a second grinding station. In the second grinding station, the backside surface of the roughly ground wafer may be finely ground (fine polished or finished) to remove micro cracks. A second grinding apparatus 100b may be arranged in the second zone Z2. Similarly to the first grinding apparatus 100a, the second grinding apparatus 100b may include a spindle 110 having a rotating shaft 112 that is connected to a driving motor and is rotatable about its own axis and a grinding wheel 300 that rotates by the rotating shaft 112 to grind the backside surface of the wafer.

After the fine grinding is completed in the second zone Z2, the first chuck table 52 may be moved to the third zone Z3. The third zone Z3 may be provided as a polishing station. In the polishing station, the backside surface of the finely ground wafer may be finished into a flat surface. The polishing apparatus 60 may be arranged in the third zone Z3. The polishing apparatus 60 may include a spindle and a polishing head connected to the spindle.

The cleaning nozzle 62 may function to remove dust and residues generated during wafer polishing at the polishing station. In order to remove the dust or residues accumulated inside the wafer surface processing apparatus, the cleaning nozzle 62 may be placed between the second grinding station and the polishing station, and a cleaning liquid such as water may be continuously supplied, thereby preventing dust and residues from accumulating inside the wafer surface processing apparatus 10.

The spinner table 70 may function to remove water, dust, and foreign substances remaining on the wafer due to the water supply after wafer polishing. In addition, the accumulated dust and residues may be blocked to prevent a vortex phenomenon between each spindle.

As illustrated in FIG. 2, the grinding apparatus 100, 100a, 100b may include a spindle 110, a spindle housing 120 that accommodates the spindle 110, a spindle support that supports the spindle housing 120, and a grinding feed unit 160.

The spindle support may be mounted on a movement block 150 that is movable up and down along a pair of guide rails 152. A column 14 extending in a vertical direction may be provided at the rear of a base 12 on which the turn table 40 is disposed, and the pair of guide rails 152 may be provided on the column 14.

The grinding feed unit 160 may include a ball screw 164 that moves the spindle 110 up and down along the pair of guide rails 152 and a pulse motor 162. The ball screw 164 may be rotated by driving the pulse motor 162, so that the movement block 150 may move up and down.

As illustrated in FIG. 3, the grinding apparatus 100 may grind the backside surface of the wafer W on the second chuck table 54. The grinding apparatus 100 may include a spindle 110, a mount disk 200 fixed to the spindle 110, and a grinding wheel 300 detachably mounted on the mount disk 200 and configured to grind one surface of the wafer W.

The second chuck table 54 may hold the wafer W. The grinding wheel 300 detachably mounted on the mount disk 200 may include an annular-shaped wheel base 310 and a plurality of blades 320 spaced apart along a circumference of the wheel base 310 on a lower surface of the wheel base 310.

The plurality of blades 320 may include abrasive particles and a binder. The abrasive particles may include diamond, cubic boron nitride (CBN), calcium carbonate, emery, novaculite, ferric oxide, ceramic, alumina, glass, silica, silicon carbide, zirconia, etc. In one embodiment, the abrasive particles may include diamond. The abrasive particles may be provided in a mixed form with the binder. For example, the binder may surround the abrasive particles. The plurality of abrasive particles included in each of the plurality of blades 320 may have an average particle size of 300 to 1000 mesh.

The rotating shaft 112 of the spindle 110 may rotate around a rotation axis that is perpendicular to a holding surface of the chuck table 54. The grinding feed unit 160 may feed the spindle 110 in the direction of the rotation axis of the spindle 110. For example, while the chuck table 54 holds and rotates the wafer W at, for example, 300 rpm, the spindle 110 may be rotated in the direction of the arrow R at, for example, 3,200 rpm. At this time, the grinding feed unit 160 may grind and feed the spindle 110 in the direction of the arrow Z to grind the wafer W held on the chuck table 54.

A grinding process by the grinding apparatus 100 may be divided into three sections according to a grinding feed rate of the spindle 110. In the first section the spindle 110 may be fed at a first grinding feed rate, in the second section the spindle 110 may be fed at a second grinding feed rate, and in the third section the spindle 110 may be fed at a third grinding feed rate. For example, the first grinding feed rate may be 4.5 μm/s, the second grinding feed rate may be 3.0 μm/s, and the third grinding feed rate may be 1.0 m/s.

When the grinding process progresses from the first section to the second section, vibration in the Z-axis direction may increase by about two times. As described below, according to example embodiments, the mount disk 200 on which the grinding wheel 300 is mounted may be a damper-type mount disk including a plurality of vibration absorbing dampers therein. The damper-type mount disk 200 may effectively dampen or alleviate the vibration of the spindle 110 by primarily damping the vibration in the Z-axis direction generated during the grinding process.

Hereinafter, a grinding apparatus having the damper-type mount disk will be described in detail.

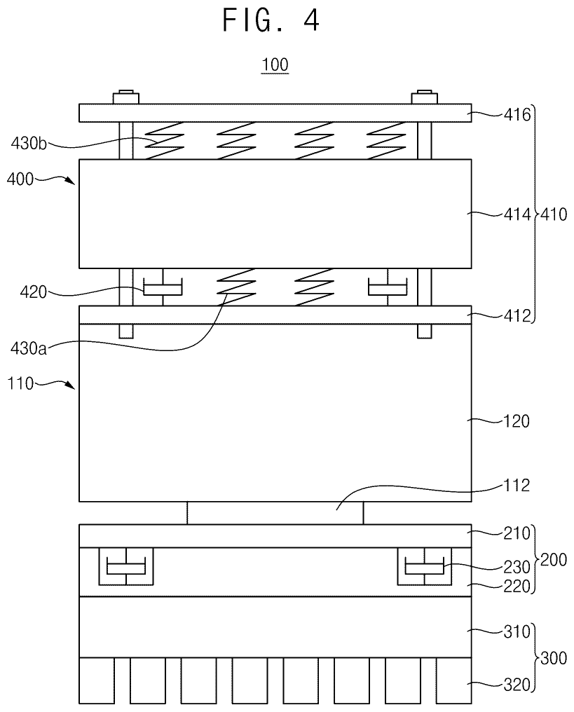

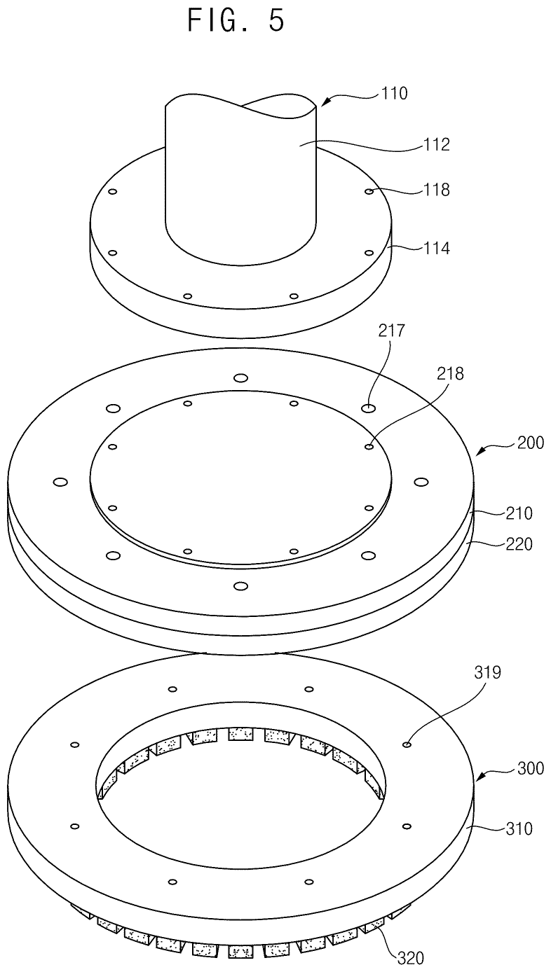

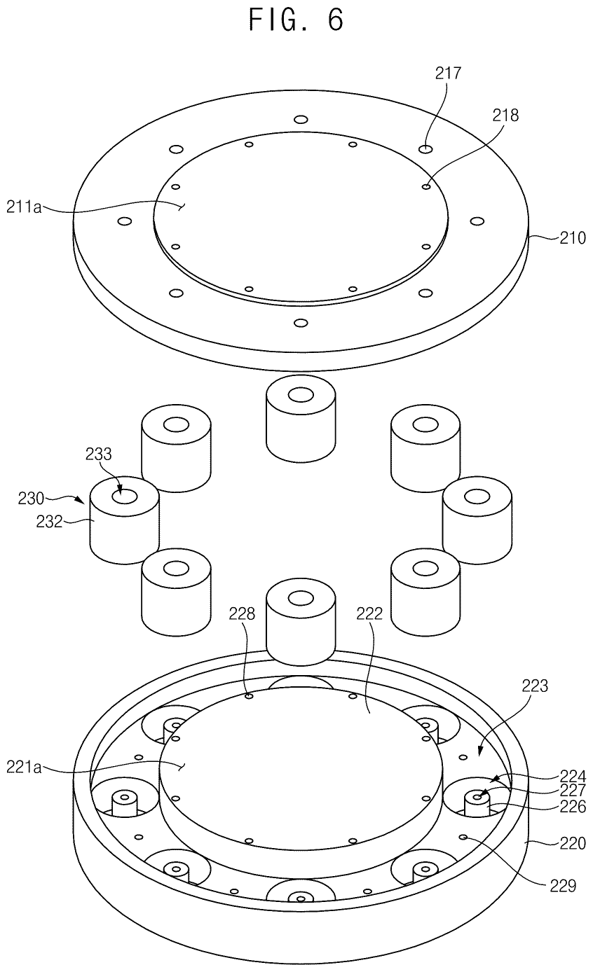

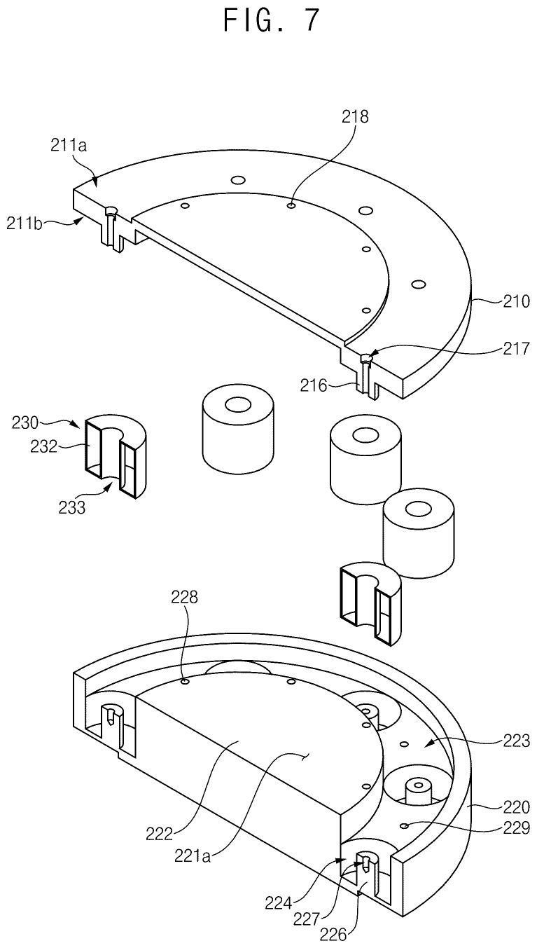

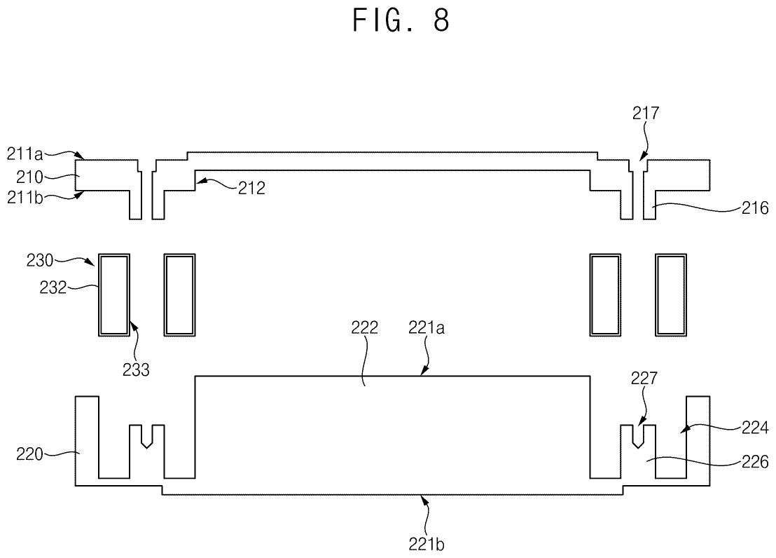

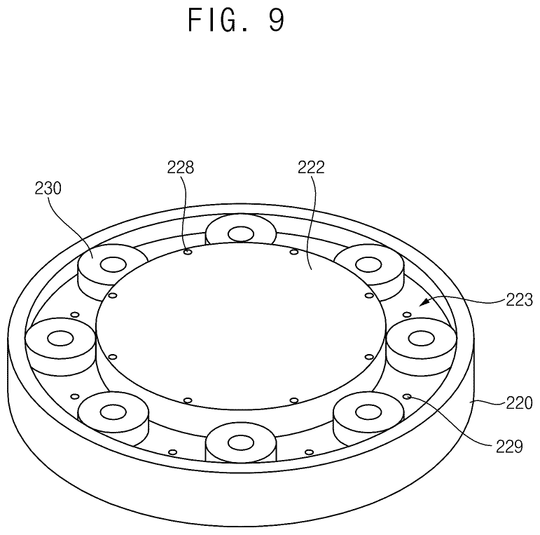

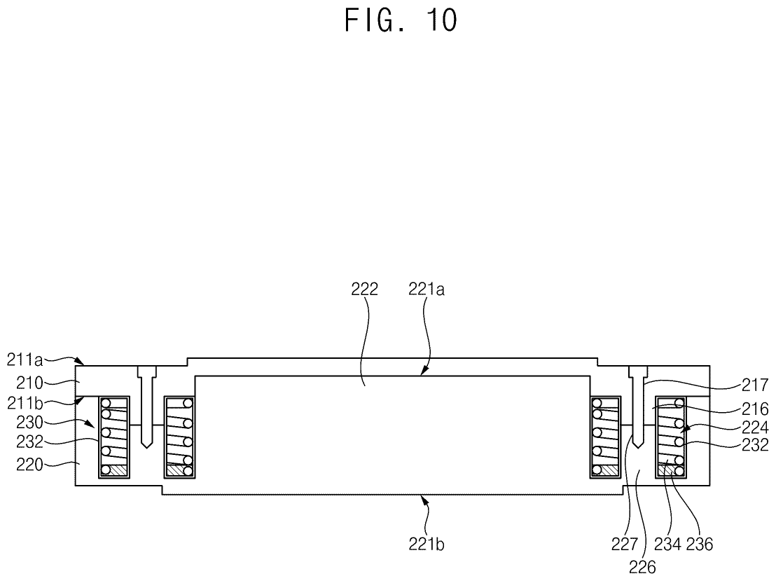

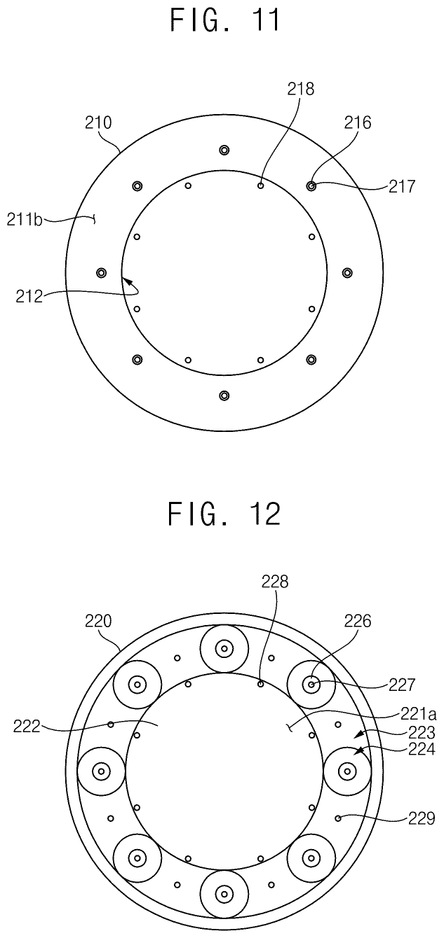

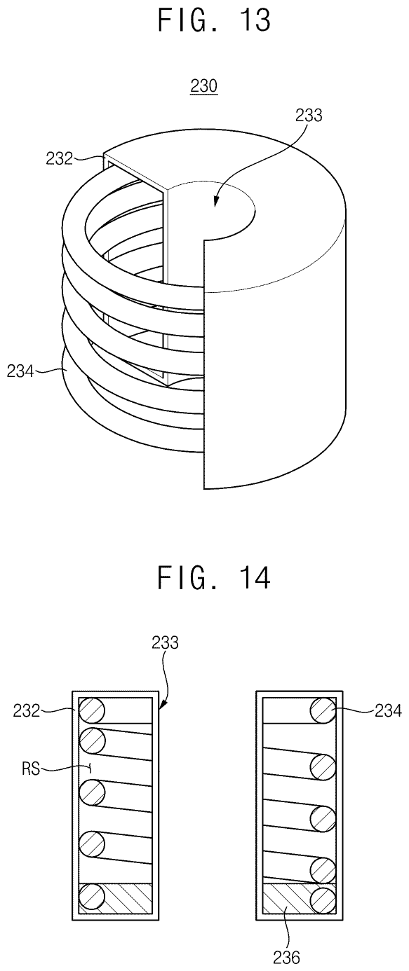

FIG. 4 is a block diagram illustrating a grinding apparatus in accordance with example embodiments. FIG. 5 is an exploded perspective view illustrating the grinding apparatus of FIG. 4. FIG. 6 is an exploded perspective view illustrating a mount disk of FIG. 5. FIG. 7 is an exploded cross-sectional perspective view illustrating the mount disk of FIG. 6. FIG. 8 is an exploded cross-sectional view illustrating the mount disk of FIG. 5. FIG. 9 is a perspective view illustrating a plurality of vibration absorbing dampers arranged on a lower disk of FIG. 5. FIG. 10 is a cross-sectional view illustrating the mount disk of FIG. 5. FIG. 11 is a plan view illustrating a lower surface of an upper disk of the mount disk of FIG. 5. FIG. 12 is a plan view illustrating an upper surface of the lower disk of the mount disk of FIG. 5. FIG. 13 is a partially cut-away perspective view illustrating the vibration absorbing damper of the mount disk of FIG. 6. FIG. 14 is a cross-sectional view illustrating the vibration absorbing damper of FIG. 13.

Referring to FIGS. 4 to 14, a grinding apparatus 100 may include a spindle 110, a damper-type mount disk 200, and a grinding wheel 300. The damper-type mount disk 200 may include an upper disk 210, a lower disk 220 fastened to the upper disk 210, and a plurality of vibration absorbing dampers 230 fixedly supported between the upper disk 210 and the lower disk 220 that are fastened to each other. The grinding apparatus 100 may further include a vibration damping device 400.

In example embodiments, the spindle 110 may have a rotating shaft 112. The rotating shaft 112 may be rotated by a driving motor. The upper disk 210 of the damper-type mount disk 200 may be fixed to a lower portion of the rotating shaft 112. The lower disk 220 may be fastened to the upper disk 210.

The upper disk 210 may be a circular plate. The upper disk 210 may have a first surface 211a as an upper surface and a second surface 211b as a lower surface opposite to the first surface 211a. The first surface 211a may be a fastening surface with the rotating shaft 112, and the second surface 211b may be a fastening surface with the lower disk 220. The lower disk 220 may be a circular plate corresponding to the upper disk 210. The lower disk 220 may have a third surface 221a as an upper surface and a fourth surface 221b as a lower surface opposite to the third surface 221a. The third surface 221a may be a fastening surface with the upper disk 210, and the fourth surface 221b may be a fastening surface with the grinding wheel 300.

The lower disk 220 may have a fastening protrusion 222 that protrudes upward from the lower disk 220 at a central region thereof, and the upper disk 210 may have a protrusion receiving recess 212 that has a predetermined depth from the lower surface 211b and is sized to receive the fastening protrusion 222. A groove 223 may be formed in the upper surface of the lower disk 220 and may extend along an outer circumference of the lower disk 220 and the groove 223 may have an inner surface defined by the fastening protrusion 222.

For example, the upper disk 210 and the lower disk 220 may be fastened to a flange 114 provided at a lower end portion of the rotating shaft 112 using fastening members such as fastening bolts. The flange 114 provided at the lower end portion of the rotating shaft 112 may have fixing holes 118 that are formed along the circumference, the protrusion receiving recess 212 of the upper disk 210 may have first fastening holes 218 that are formed corresponding to the fixing holes 118, and the fastening protrusion 222 of the lower disk 220 may have second fastening holes 228 that are formed corresponding to the first fastening holes 218. The fixing holes 118, the first fastening holes 218, and the second fastening holes 228 may be screw holes having screw threads for coupling with the fastening bolts. The upper disk 210 may be fixed to the lower portion of the rotating shaft 112 and the lower disk 220 may be fastened to the upper disk 210 by coupling the fastening bolts to the fixing holes 118 through the second fastening holes 228 and the first fastening holes 218. However, the arrangement, number, and coupling relationships of the fixing holes, the first fastening holes, and the second fastening holes are not limited thereto.

In example embodiments, the plurality of vibration absorbing dampers 230 may be fastened between the upper disk 210 and the lower disk 220 in a sandwich manner. The lower disk 220 may have a plurality of receiving recesses 224 that are arranged at equal intervals at a predetermined angle in a circumferential direction with respect to the center thereof. The plurality of receiving recesses 224 may be formed in a bottom surface of the groove 223. For example, the number of the plurality of receiving recesses 224 may be eight, but it is not limited thereto.

Each of the receiving recesses 224 may have a circular cylindrical shape, and the vibration absorbing damper 230 may have a corresponding shape. Each of the plurality of receiving recesses 224 may have a predetermined depth from the bottom surface of the groove 223. The predetermined depth may be less than a height of the vibration absorbing damper 230 (e.g., an uncompressed height of the vibration absorbing damper 230). Accordingly, an upper portion of the vibration absorbing damper 230 may protrude from the receiving recess 224.

In example embodiments, the lower disk 220 may include a lower fixing pin 226 that protrudes from the bottom surface of the receiving recess 224, and the upper disk 210 may include an upper fixing pin 216 that protrudes from the lower surface 211b and comes into contact with the lower fixing pin 226. Each of the vibration absorbing dampers 230 may include a through cavity 233 in a central region thereof (e.g., a through hole). When the upper disk 210 and the lower disk 220 are fastened to each other, the upper fixing pin 216 and the lower fixing pin 226 may come into contact with each other within the through cavity 233 of the vibration absorbing damper 230.

The upper fixing pin 216 may have an upper fastening hole 217 that extends in a longitudinal direction (vertically), and the lower fixing pin 226 may have a lower fastening hole 227 that extends in a longitudinal direction (vertically) to correspond to the upper fastening hole 217. The upper fastening hole 217 may be formed such that the upper fixing pin 216 passes through and penetrates the upper disk 210, and the lower fastening hole 227 may be formed to have a predetermined depth from an upper surface of the lower fixing pin 226. The upper fastening hole 217 and the lower fastening hole 227 may be screw holes having threads formed therein for coupling with a fastening bolt. The fastening bolt may be coupled to the lower fastening hole 227 through the upper fastening hole 217, thereby more firmly supporting the vibration absorbing damper 230 between the upper disk 210 and the lower disk 220. An upper surface of the vibration absorbing damper 230 may be supported by contacting the lower surface 211b of the upper disk 210, and a lower surface of the vibration absorbing damper 230 may be supported by contacting the bottom surface of the receiving recess 224 of the lower disk 210 (e.g., the vibration absorbing damper 230 may be compressed between the lower surface 211b of the upper disk 210 and bottom surface of the receiving recess 224 of the lower disk 210). In some embodiments, the lower surface of the 211b of the upper disk 210b may have at least one recess respectively corresponding to the receiving recesses 224 and the upper surface of the vibration absorbing damper 230 may be supported by contacting the lower surface 211b of the upper disk 210 in the recess, and a lower surface of the vibration absorbing damper 230 may be supported by contacting the bottom surface of the receiving recess 224 of the lower disk 210.

In example embodiments, each of the vibration absorbing dampers 230 may include a damper housing 232 having an annular column-shaped receiving space RS therein, a spring 234 disposed within the receiving space RS of the damper housing 232, and a damping fluid 236 partially filling the receiving space RS. In example embodiments, each of the vibration absorbing dampers 230 may be a tuned mass damper (TMD). For example, the spring 234 may support a tuned mass. The combination of the tuned mass, spring 234, and the damping fluid 236 may dampen vibrations.

The damper housing 232 may include a material having excellent heat resistance, chemical resistance, and waterproofing properties. For example, the damper housing 232 may include a silicone material. Alternatively, the damper housing 232 may include an elastic material such as rubber.

The spring 234 may include a coil spring. The spring 234 may minimize deformation of the silicone material of the damper housing 232 and simultaneously perform a vibration damping function. A flange-shaped fixing portion may be formed on a lower inner surface and an upper inner surface of the damper housing 232 to fix one end portion of the spring 234.

The damping fluid 236 may be provided to fill 10% to 30% of the receiving space RS of the damper housing 232. An amount of the damping fluid 236 filling the receiving space RS of the damper housing 232 may be determined in consideration of a damping ratio (damping coefficient).

The damping fluid 236 may include a dilatant fluid. The dilatant fluid may be a non-Newtonian fluids and may be a fluid having a characteristic in which viscosity increases with the rate of shear strain. Since the viscosity of the dilatant fluid increases as the shear rate increases, it may exhibit greater resistance at higher frequencies. As the rotational speed of the spindle 110 increases, the viscosity of the damping fluid 236 may increase.

The coil spring 234 may be disposed in a lower housing and the damping fluid 236 may be injected into the lower housing, and then, an upper housing may be combined on the lower housing to form an integral body.

In example embodiments, the grinding wheel 300 may be detachably mounted on the mount disk 200. A wheel base 310 of the grinding wheel 300 may be a circular plate corresponding to the lower disk 220. The wheel base 310 may be fastened to the lower disk 220 using fastening members such as fastening bolts. Third fastening holes 229 may be formed in the grooves 223 of the lower disk 220, and fourth fastening holes 319 may be formed in the wheel base 310 corresponding to the third fastening holes 229, respectively. The third fastening holes 229 and the fourth fastening holes 319 may be screw holes having screw threads for coupling with the fastening bolts. The wheel base 310 may be fixed to the lower surface 221b of the lower disk 220 by coupling the fastening bolts to the third fastening holes 229 through the fourth fastening holes 319. However, the arrangement, number, and coupling relationships of the third fastening holes and the fourth fastening holes are not limited thereto.

In example embodiments, the vibration damping device 400 may be disposed on a spindle 110 to damp vibration of the spindle 110.

The vibration damping device 400 may include a plurality of weights 410, a plurality of dampers 420, and a plurality of springs 430a, 430b. In addition, the vibration damping device 400 may further include a plurality of pressurizing modules.

The weights 410 may be disposed on an upper portion of the spindle 110. The weights 410 may be stacked along a vertical direction on an upper surface of the spindle 110. For example, each of the weights may have a horse's hoof shape, but may not be limited thereto.

For example, the weights 410 may include a bottom weight 412, a middle weight 414, and a top weight 416. The middle weight 414 may include a plurality of stacked weights.

The dampers 420 may be interposed between the bottom weight 412 and the middle weight 414. The dampers 420 may attenuate or alleviate the vibration of the spindle 110 applied to the bottom weight 410. The dampers 420 may not be limited to a specific structure and may have various structures that may reduce the vibration of the spindle 110.

The plurality of springs may include a plurality of lower springs 430a and a plurality of upper springs 430b. The plurality of lower springs 430a may be interposed between the bottom weight 412 and the middle weight 414. The plurality of upper springs 430b may be interposed between the middle weight 414 and the top weight 416.

The pressurizing modules may selectively connect each of the upper springs 430b to any one of the neighboring weights. The pressurizing modules may selectively pressurize upper end portions of the springs 430b downward.

As described above, the grinding apparatus 100 may include the spindle 110, the damper-type mount disk 200, and the grinding wheel 300. The damper-type mount disk 200 may include the upper disk 210, the lower disk 220 fastened to the upper disk 210, and the plurality of vibration absorbing dampers 230 fixedly supported between the upper disk 210 and the lower disk 220 fastened to each other.

Each of the vibration absorbing dampers 230 may include the damper housing 232 having the annular column-shaped receiving space RS therein, the spring 234 disposed within the receiving space RS of the damper housing 232, and the damping fluid 236 partially filling the receiving space RS.

The damper-type mount disk 200 may primarily dampen or alleviate the vibration in the Z-axis direction that occurs during the grinding process, to effectively dampen the vibration of the spindle 110.

The above grinding apparatus may be used to manufacture a semiconductor package including semiconductor devices such as logic devices or memory devices. The semiconductor package may include logic devices such as central processing units (CPUs), main processing units (MPUs), or application processors (APs), or the like, and volatile memory devices such as DRAM devices, HBM devices, or non-volatile memory devices such as flash memory devices, PRAM devices, MRAM devices, ReRAM devices, or the like.

The foregoing is illustrative of example embodiments and is not to be construed as limiting thereof. Although a few example embodiments have been described, those skilled in the art will readily appreciate that many modifications of the example embodiments are possible without materially departing from the novel teachings and advantages of the present invention. Accordingly, all such modifications are intended to be included within the scope of the present invention as defined in the claims.

What is claimed is:

1. A grinding apparatus, comprising:
a spindle having a rotating shaft;
a mount disk having an upper disk fixed to a lower portion of the rotating shaft, a lower disk fastened to the upper disk, and a plurality of vibration absorbing dampers fixedly supported between the upper disk and the lower disk that are fastened to each other; and
a grinding wheel detachably mounted to the mount disk.

2. The grinding apparatus of claim 1, wherein the lower disk has a plurality of receiving recesses that are each arranged at equal intervals at a predetermined angle in a circumferential direction with respect to the center of the lower disk, and the plurality of vibration absorbing dampers are each disposed in a respective receiving recess of the plurality of receiving recesses.

3. The grinding apparatus of claim 2, wherein the lower disk has a groove that extends along an outer circumference of the lower disk, and the plurality of receiving recesses are formed in a bottom surface of the groove to have a predetermined depth from the bottom surface of the groove, and the predetermined depth is less than an uncompressed height of each of the vibration absorbing dampers.

4. The grinding apparatus of claim 2, wherein:
each of the vibration absorbing dampers includes a through cavity in a central region thereof,
the lower disk includes lower fixing pins that each protrudes from a bottom surface of a respective receiving recess and is arranged in the through cavity of a respective vibration absorbing damper, and
the upper disk includes upper fixing pins that protrude from a bottom surface of the upper disk and are each arranged in the through cavity of a respective vibration absorbing damper to be in contact with a respective lower fixing pin.

5. The grinding apparatus of claim 4, wherein each of the lower fixing pins has a lower fixing hole that extends in a longitudinal direction of the respective lower fixing pin, and each of the upper fixing pins has an upper fixing hole that extends in a longitudinal direction thereof to correspond to a respective lower fixing hole.

6. The grinding apparatus of claim 1, wherein each of the vibration absorbing dampers includes:
a damper housing having an annular column-shaped receiving space therein;
a spring disposed within the receiving space of the damper housing; and
a damping fluid partially filling the receiving space.

7. The grinding apparatus of claim 6, wherein the damper housing of each of the vibration absorbing dampers includes a silicone material.

8. The grinding apparatus of claim 6, wherein the damping fluid comprises a dilatant fluid.

9. The grinding apparatus of claim 1, wherein the lower disk has a fastening protrusion that protrudes upward at a central region thereof, and the upper disk has a protrusion receiving recess that has a predetermined depth from a lower surface thereof to receive the fastening protrusion.

10. The grinding apparatus of claim 1, further comprising:
a vibration damping device arranged on the spindle and configured to dampen vibration of the spindle.

11. A grinding apparatus, comprising:
a spindle having a rotating shaft;
a mount disk fixed to a lower portion of the rotating shaft; and
a grinding wheel detachably mounted on the mount disk,
wherein the mount disk includes:
a lower disk having a plurality of receiving recesses;
vibration absorbing dampers respectively arranged in the plurality of receiving recesses; and
an upper disk coupled to the lower disk and covering the vibration absorbing dampers.

12. The grinding apparatus of claim 11, wherein the lower disk has a groove that extends along an outer circumference of the lower disk, and each receiving recess of the plurality of receiving recesses is arranged on a bottom surface of the groove at equal intervals at a predetermined angle in a circumferential direction with respect to the center of the lower disk.

13. The grinding apparatus of claim 12, wherein each of the plurality of receiving recesses has a predetermined depth from the bottom surface of the groove, and the predetermined depth is less than an uncompressed height of the vibration absorbing dampers.

14. The grinding apparatus of claim 11, wherein each of the vibration absorbing dampers includes a through cavity in a central region thereof,
the lower disk includes lower fixing pins that protrude from a bottom surface of a respective receiving recess, wherein each of the lower fixing pins is disposed in the through cavity of a respective vibration absorbing damper, and
the upper disk includes upper fixing pins that protrude from the bottom surface of the upper disk, wherein each upper fixing pin is disposed in the through cavity of a respective vibration absorbing damper to be in contact with a respective lower fixing pin.

15. The grinding apparatus of claim 14, wherein each of the lower fixing pins has a lower fixing hole that extends in a longitudinal direction thereof, and each of the upper fixing pins has an upper fixing hole that extends in a longitudinal direction to correspond to a respective lower fixing hole.

16. The grinding apparatus of claim 11, wherein each of the vibration absorbing dampers comprises:
a damper housing having an annular column-shaped receiving space therein;
a spring disposed within the receiving space of the damper housing; and
a damping fluid partially filling the receiving space.

17. The grinding apparatus of claim 16, wherein the damper housing includes a silicone material.

18. The grinding apparatus of claim 16, wherein the damping fluid includes a dilatant fluid.

19. The grinding apparatus of claim 11, further comprising:
a vibration damping device arranged on the spindle and configured to dampen vibration of the spindle.

20. A grinding apparatus, comprising:
a spindle having a rotating shaft;
a mount disk having an upper disk fixed to a lower portion of the rotating shaft, a lower disk fastened to the upper disk, and a plurality of vibration absorbing dampers fixedly supported between the upper disk and the lower disk that are fastened to each other; and
a grinding wheel detachably mounted to the mount disk,
wherein each of the vibration absorbing dampers includes:
a damper housing having an annular column-shaped receiving space therein;
a spring disposed within the receiving space of the damper housing; and
a damping fluid partially filling the receiving space.
